(19) United States
(12) Patent Application Publication
(10) Pub. No.: US 2007/0122766 A1
(43) Pub. Date: May 31, 2007

(54) Alginate band fastener

(76) Inventor: Myron Alexander Wilson, Aurora, CO (US)

Correspondence Address: BARBER LEGAL, P.O. BOX 16220, GOLDEN, CO, 80402-6004, US

(21) Appl. No.: 11/290,369

(22) Filed: Nov. 29, 2005

(51) Int. Cl. A61C 19/00

(52) U.S. Cl. 433/74

(57) ABSTRACT

The present invention teaches an alginate band fastener device which may be inserted across the alginate band and tooth void of the gutta percha negative mold, then left in place while the mold is filled with gypsum, plaster or other hard material and vibrated, the alginate band fastener holding the band in exact position during the entire process. The fastener may have a cross bar, two or more barbs extending downward from the cross bar, and at least one detent aiding in clasping of the alginate band. In embodiments, there may be four barbs extending downward in pairs, each pair clasping one side of an alginate band, there may be two barbs both of which clasp a single portion of an alginate band, or there may be two barbs which generally sit across the alginate band on distal portions of it.

### CROSS-REFERENCE TO RELATED APPLICATIONS

N/A

### FIELD OF THE INVENTION

This invention relates generally to orthodontic devices, and specifically to creation of orthodontic positive molds of teeth, with alginate bands accurately placed thereon, such as are used to create braces.

### STATEMENT REGARDING FEDERALLY FUNDED RESEARCH

This invention was not made under contract with an agency of the US Government, nor by any agency of the US Government.

### BACKGROUND OF THE INVENTION

Making of dental appliances such as braces is a difficult, multistep task. In the broadest terms, the process breaks down into making a soft negative impression from the patient's teeth, making a positive impression out of hard material and removing the softer negative from around it, and then making the actual braces, retainer or other appliance using the hard positive model.

The dental appliance is typically anchored on the alginate bands or crowns, meaning that the alginate bands/crowns are of special importance. Yet the process of making the hard positive cast or model may be detrimental to accurate placement of the alginate bands. The process, in more detail, is as follows. The soft negative impression is usually made from gutta percha or a similar material which hardens promptly into a soft rubber mold of the patient's teeth, but in negative. Since it is in negative, the teeth of the patient leave a series of “tooth shaped” cavities (“voids”) in the mold. The alginate bands or crowns for the final mold are actually emplaced at this time, that is, into the soft tooth shaped cavities of the negative mold. This means that the bands should sit in mechanical or frictional engagement with the inner surface of the cavity. Since this is likely to fail to secure the alginate band in place, an ordinary staple may be used, or beeswax, high strength glue such as SUPERGLUE™ or the like, in an attempt to hold the alginate band in exact alignment. Making of the positive from the negative involves pouring plaster, gypsum, or a similar material into the voids of the negative, a process which by itself may dislodge the alginate bands and may lead to dislodgement when the vibrator is used. Since the mixture is thick and quite viscous, it is then necessary to actually vigorously vibrate the entire assembly so as to spread the gypsum or plaster throughout the voids which represent the teeth. Needless to say, the vibration of the soft rubber mold is yet another excellent opportunity for the alginate bands to dislodge themselves.

When the gypsum has hardened, the rubber mold is essentially “ripped away” to reveal the final positive impression or model. Auxiliary metal attachments may then be attached to the alginate bands which anchor the appliance by soldering or arc welding to the material, thereby reshaping the original form of the band. The high strength of gypsum or the like is thus necessary to the process.

At the point at which the rubber mold material is removed from the positive, the results and success (or failure) of the process may be determined. If the shaking was insufficiently vigorous, the material may not have completely filled the tooth voids, meaning that portions of the teeth of the patient are simply not represented on the positive impression. But on the other hand, the alginate bands may have come dislodged and ended up in incorrect placement on the replica gypsum teeth of the positive impression. Obviously, since the Alginate bands will in the end anchor the patient's dental appliance, and since the exact shape of the teeth and placement of the bands in a necessity, either mistake means that the appliance cannot be manufactured with 100% accuracy and the process must be repeated. The difficulty of this exacting task may be understood from the following statistic: approximately one ninth of positive molds must be discarded and the process repeated, usually because of problems with seating of the alginate band/crown.

Searching in class 433 (Dentistry) of the collection of US patents reveals a number of pins, fasteners and other devices largely unrelated to the present invention.

U.S. Pat. No. 6,884,072 issued Apr. 26, 2005 to Pawlus teaches a pin for the underside of a die unrelated to alginate bands, crowns, or the securing of such bands/crowns.

U.S. Pat. No. 6,848,903 issued Feb. 1, 2005 to Stadtmiller teaches an alginate band with a reference mark enabling a precise fit of the appliance to the band, but not of the band to a positive of patient teeth.

U.S. Pat. No. 6,238,212 issued May 29, 2001 to Khachatoorian et al teaches a method and apparatus for applying an adhesive to a band.

U.S. Pat. No. 5,911,575 issued Jun. 15, 1999 to inventor Devanathan teaches an improved orthodontic band, but not a method or device for fastening such a band into a negative mold cavity.

U.S. Pat. No. 5,775,899 issued to inventor Huffman on Jul. 7, 1998 teaches a model may have pins set into it, but does not teach regarding securing of an alginate band.

U.S. Pat. No. 5,647,744 issued to Squicciarini on Jul. 15, 1997 teaches a casting element for making of a gypsum model.

U.S. Pat. No. 5,441,409 issued Aug. 15, 1995 to Tuneberg for an orthodontic band teaches-an improved band but not any device for holding it in place in a negative model.

U.S. Pat. No. 5,257,439 issued Nov. 2, 1993 to Leblanc teaches a clamp for a band, however the clamp if for the band itself and not structurally similar to the present invention.

U.S. Pat. No. 4,778,386 issued to Spiry on Oct. 18, 1988 teaches a somewhat “tooth shaped” ring for crown construction.

U.S. Pat. No. 4,735,570 issued Apr. 5, 1988 to Chen teaches a tooth attachment for false teeth, but is not relevant to placement of alginate bands into negative molds.

U.S. Pat. No. 3,343,247 issued Sep. 26, 1967 to Dillberg et al teaches pre-formed alginate bands, rather than any particular method or device relevant to the present invention or to otherwise securing such bands in place in a tooth void of a negative mold.

U.S. Pat. No. 2,742,700 issued Apr. 24, 1956 to Ramsperger teaches an artificial tooth with a peg or pin in it, but not apparently for use in a gutta percha mold.

U.S. Pat. No. 2,566,414 issued Sep. 4, 1951 to Henry teaches an orthodontic arch and procedure.

U.S. Pat. No. 2,025,344 issued Dec. 24, 1935 to Fischer teaches a blank for artificial teeth. The blank has a peg emplaced therein to aid securing it to a substrate.

U.S. Pat. No. 1,547,631 issued Jul. 28, 1925 to Warfel teaches an artificial teeth mold, pegs may be used to secure various items to a substrate.

U.S. Pat. No. 970,096 issued Sep. 13, 1910 to MicPhillips is similar to the previous item in teaching moldings with pegs thereon.

U.S. Pat. No. 613,711 issued Nov. 8, 1898 to Page and Bloom also shows a mold for artificial teeth and posts therewith.

It would be preferable to provide a device by use of which a positive mold could have an alginate band or crown secured in a very reliable and exact manner within the tooth void, so that the final model of gypsum did not display the problem of bands coming loose during the vibration needed to make a high quality model.

### SUMMARY OF THE INVENTION

### General Summary

The present invention teaches an alginate band fastener device which may be inserted across the Alginate band and tooth void of the gutta percha negative mold, then left in place while the mold is filled with gypsum, plaster or other hard material and vibrated, the alginate band fastener holding the band in exact position during the entire process.

The fastener may have a cross bar, two or more barbs extending downward from the cross bar, and at least one detent aiding in clasping of the alginate band. In embodiments, there may be four barbs extending downward in pairs, each pair clasping one side of an alginate band, there may be two barbs both of which clasp a single portion of an alginate band, or there may be two barbs which generally sit across the alginate band on distal portions of it.

### Summary in Reference to Claims

It is therefore a first aspect, advantage, objective and embodiment of the invention to provide an alginate band fastener for use with an alginate band and a soft substrate, the alginate band having an outer configuration, the alginate band fastener comprising:
a cross piece having first and second ends;
at least a first barb projecting from the cross piece at the first end;
at least a second barb projecting from the cross piece at the second end, the second barb approximately parallel to the first barb;
at least the first barb having a first detent dimensioned and configured to physically engage to such alginate band.

It is therefore a second aspect, advantage, objective and embodiment of the invention to provide an alginate band fastener further comprising:
at least one additional detent dimensioned and configured to physically engage such alginate band, the additional detent located upon the second barb.

It is therefore another aspect, advantage, objective and embodiment of the invention to provide an alginate band fastener further comprising:
a second detent on the first barb, the second detent also dimensioned and configured to physically engage to such alginate band.

It is therefore another aspect, advantage, objective and embodiment of the invention to provide an alginate band fastener further comprising:
a third detent on the first barb, the third detent also dimensioned and configured to physically engage to such alginate band.

It is therefore another aspect, advantage, objective and embodiment of the invention to provide an alginate band fastener further comprising:
a third barb projecting from cross piece at the first end, the third barb projecting approximately parallel to the first barb;
a fourth barb projecting from cross piece at the second end, the fourth barb projecting approximately parallel to the second barb;
wherein the first and third barbs have ends disposed in the range from approximately 0.020 to 0.025 inch from each other; and
wherein the second and fourth barbs have ends disposed in the range from approximately 0.020 to 0.025 inch from each other

It is therefore another aspect, advantage, objective and embodiment of the invention to provide an alginate band fastener further comprising:
second and third detents on the first barb, the second and third detents also dimensioned and configured to physically engage to such alginate band;
three additional detents on the second barb, the three additional detents also dimensioned and configured to physically engage to such alginate band;
wherein the third and fourth barbs are approximately straight.

It is therefore another aspect, advantage, objective and embodiment of the invention to provide an alginate band fastener wherein the cross piece and four barbs further comprise:
wire having a diameter in the range from 0.02 inch to 0.08 inch.

It is therefore another aspect, advantage, objective and embodiment of the invention to provide an, alginate band fastener wherein the wire further comprises one member selected from the set consisting of: stainless steel, nickel, brass, bronze, ABS plastic, polymer composites and combinations thereof.

It is therefore another aspect, advantage, objective and embodiment of the invention to provide an alginate band fastener for use with an alginate band and a soft substrate, the alginate band having an outer configuration, the alginate band fastener comprising:
a straight portion having a first end and a second end;
a loop portion projecting from the second end of the straight portion; and
a detent carrying portion projecting from the loop portion approximately parallel to the straight portion, the detent carrying portion having at least one detent dimensioned and configured to physically engage to such alginate band, the detent carrying portion having a first end.

It is therefore a further aspect, advantage, objective and embodiment of the invention to provide an alginate band fastener further comprising:
wire having a diameter in the range from 0.02 inch to 0.04 inch.

It is therefore another aspect, advantage, objective and embodiment of the invention to provide an alginate band fastener wherein the wire further comprises one member selected from the set consisting of: stainless steel, nickel, brass, bronze, ABS plastic, polymer composites and combinations thereof.

It is therefore yet another aspect, advantage, objective and embodiment of the invention to provide an alginate band fastener wherein the first end of the detent carrying portion and the first end of the straight portion are disposed approximately 0.02 inch apart.

It is therefore another aspect, advantage, objective and embodiment of the invention to provide an alginate band fastener wherein the loop portion has a width in the range from 0.1 inch inclusive to 0.24 inch exclusive.

It is therefore another aspect, advantage, objective and embodiment of the invention to provide an alginate band fastener wherein the loop portion has a width in the range from 0.24 inch to 0.25 inch.

It is therefore another aspect, advantage, objective and embodiment of the invention to provide an alginate band fastener wherein the loop portion has a width in the range from 0.25 inch exclusive to 0.5 inch inclusive.

### BRIEF DESCRIPTION OF THE DRAWINGS

FIG. 1 is a side view of a first embodiment of the device having two barbs and a cross piece.

FIG. 2 is a side view of a second embodiment of the device having two barbs and a loop.

FIG. 3 is a side view of a third embodiment of the device having four barbs and a cross piece, this is the presently preferred embodiment and best mode now contemplated for carrying out the invention.

FIG. 4 is an elevated side view of the third embodiment of the invention in use on an Alginate band.

FIG. 5 is a top planform view of the first embodiment of the device in use on a gutta percha negative mold.

FIG. 6 is a side view of an embodiment having the end of the barb ending with a bend outwards for enhanced ease of use.

### INDEX OF REFERENCE NUMERALS

First Embodiment 100
Cross piece 102
Cross piece first end 104
Cross piece second end 106
First barb 108
Second barb 110
Petents 130
Length of cross piece A
Length of barbs B
Diameter of wire C
Depth of detent D
Width of detent E
Second embodiment 200
Loop portion 202
Loop portion first end 204
Loop portion second end 206
Straight portion 208
Detent carrying portion 210
Detents 230
Length of loop F
Length of barb portions G
Diameter of wire H
Depth of detent I
Width of detent J
Gap K
Third embodiment 300
Cross piece 302
Cross piece first end 304
Cross piece second end 306
First barb 308
Second barb 310
Third barb 312
Fourth barb 314
Detents 330
Length of cross piece L
Length of barbs M
Diameter of wire N
Depth of detent 0
Width of detent P
Gap Q
Third embodiment 400
Cross piece 402
First barb 408
Second barb 410
Third barb 412
Fourth barb 414
Alginate Ring 460
Diameter of ring R
Thickness of ring S
Depth of ring T
First embodiment 500
Mold 550
Tooth void 552
Alginate Ring 560
Fourth embodiment 600
Increased opening width U

### DETAILED DESCRIPTION

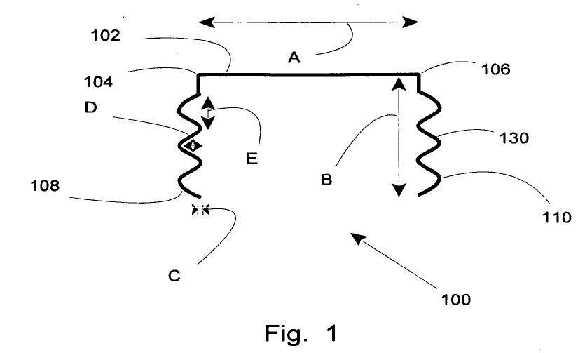

FIG. 1 is a side view of a first embodiment of the device having two barbs and a cross piece. First embodiment 100 has cross piece 102 having cross piece first end 104 and having cross piece second end 106. First barb 108 may project from one end while second barb 110 may project from the other end. The barbs project in a generally parallel manner in a direction defined as down or downward due to the fact that the position of use has these barbs projecting into the material/tooth void of a mold with the cross piece rising above as a grip.

Detents 130 on the barbs may be dimensioned and configured physically engage to an alginate band, in particular, the depth of detent (arrow D on FIG. 1) and width of detent (arrow E on FIG. 1) may be selected based upon the desired type of alginate band to which the devices may attach. In practice in the industry, a relatively small number of types of alginate bands are commonly used, however, it is known in the prior art that alginate bands of various different cross sectional shapes, depths, widths and so on may be used, and all such alginate bands now known or later developed may be used with the invention as claimed herein.

Length of cross piece (see arrow A) is also based upon the standard sizes of alginate bands, in general, the diameter of the alginate band will be approximately equaled by the length of the cross piece. Small differences may be introduced for manufacturing reasons, to make handling easier and so on. This length may advantageously be 13 mm, plus or minus several millimeters.

Length of barbs (arrow B depicts this) is based upon the depth/width of the band plus an additional distance necessary to raise the cross piece above the surface of the negative mold when in use. Advantageously, a length of 13 mm, plus or minus several millimeters, may be used. The barbs may be parallel in three dimensions or in two dimensions (parallel in one plane but not in another). The barbs may thus point towards each other, point away from each other, point in directions which do not intersect and so on.

Diameter of wire C is normally on the order of approximately 0.022 inches for metal wire of materials such as steel, stainless steel, bronze, copper and the like. The diameter may be increased or decreased, however, based on convenience, strength, handling, manufacture and the like. For example, when ABS plastic is used as the material, a similar thickness or slightly greater thickness may be used, but other polymers which may be used may lead to other choices of thicknesses.

In use, this embodiment is seated on an alginate ring at one pair of opposing detents and then the ring is inserted into the tooth void of the negative mold (the space left by the patient's tooth when the negative mold is made) with the cross piece upwards. The end result (use of the alginate ring to anchor the dental accessory) requires the ring stay in place in the mold while the positive casting is made, and the invention aids this. Note that the alginate ring may also be seated into place in the tooth mold and then the invention seated over it.

In embodiments of use, the cross piece may be “clipped”, that is, cut into two pieces, and then the two halves of the invention may be rotated as needed to achieve an even tighter fit. However, the same effect may be achieved by the next embodiment of the invention.

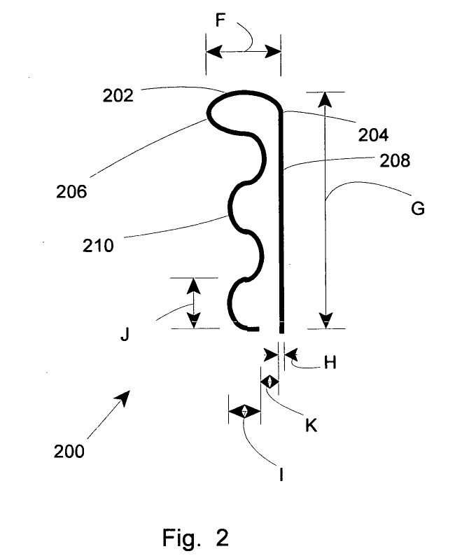

FIG. 2 is a side view of a second embodiment of the device having two barbs and a loop. This embodiment of the invention holds down one side of the ring, rather than stretching across the ring.

Second embodiment 200 has loop portion 202 having loop portion first end 204 and loop portion second end 206. Straight portion 208 and detent carrying portion 210 having detents 230 may be attached to and descend from the ends 204, 206 of the loop portion 202.

Length of loop F may be settled at a size determined to be useful for handling, such as 0.25 inch, plus or minus 0.125 inch (6.5 mm plus or minus approximately 3.5 mm). The overall length of the bar portions (G) may be 0.512 inch (roughly 13 mm), with broad ranges of alternatives (plus or minus 0.25 inch (6.5 mm).

The wire diameter H may be roughly 0.022 inch, while the gap K between the ends of the two barbs may be roughly 0.20 inch (5 mm). Depth of detent I and width of detent J may as previously mentioned by varied to suit the alginate rings the device should fit to, as may the overall shape of the detent be varied as needed. The shape, depth and width of the detents is structurally suited to physically engage the shape, thickness and width/depth of the alginate ring. For example a detent depth of 0.12 inch (roughly 3 mm) may be advantageous.

The shape, depth and width of the detents may thus match the cross section of an alginate ring, or may complement it in order to achieve the physical engagement.

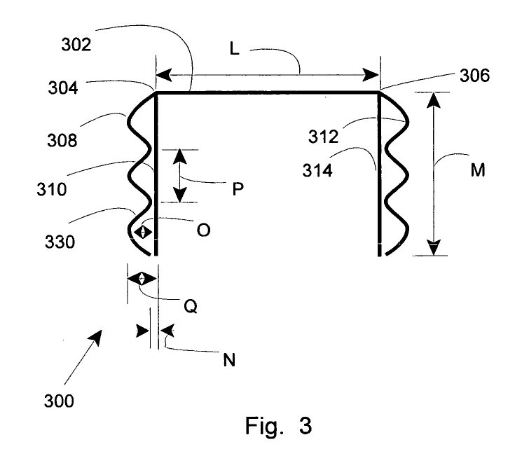

FIG. 3 is a side view of a third embodiment of the device having four barbs and a cross piece, this is the presently preferred embodiment and best mode now contemplated for carrying out the invention. This embodiment presents advantages over alternative embodiments presented herein.

Third embodiment 300 has cross piece 302 having cross piece first end 304 and cross piece second end 306, however, the ends of the cross piece 302 have two barbs projecting from them, for a total of two straight barbs and two detent carrying barbs. First barb 308, second barb 310, third barb 312 and fourth barb 314 may act in pairs much like the second embodiment of FIG. 2 acts to clasp and secure one side of the ring, but this presently preferred and best mode now contemplated also spans the diameter of the ring to act similarly on some other point on the circumference of the ring.

Detents 330 may be one sided as shown (with one flat side and one curved side), or by having two non-straight prongs acting together (disposed near to one another) may clasp any cross sectional shape of ring. For example, the two prongs may be mutually straight (for alginate rings which are substantially flat), may be mutually curved in mirror image (for alginate rings having a cross section which “bulges” inward and outward both), may have the same curves at the same points (for alginate rings which are very thin but curved), may different shapes (for alginate rings having different shapes on inner and outer surfaces) and so on.

Length of cross piece L may approximate the diameter of the alginate ring, but need not. If greater than the length of the alginate ring, the extra length may allow easier insertion on opposite sides of a tooth cavity, the barbs may be substantially parallel in one dimension but may be non-parallel in some other dimension and so on. The device may also be used with alginate rings having a diameter greater than length L, as the device may cross a chord of the circle rather than the full diameter.

Length of barbs (arrow M) may advantageously be approximately 13 mm, plus or minus 6.5 mm, and the diameter of the wire N, if ABS plastic is used, may be 0.24 inch.

Depth of detent (see arrow O) and width of detent (arrow P) and gap Q may be dimensions as described previously.

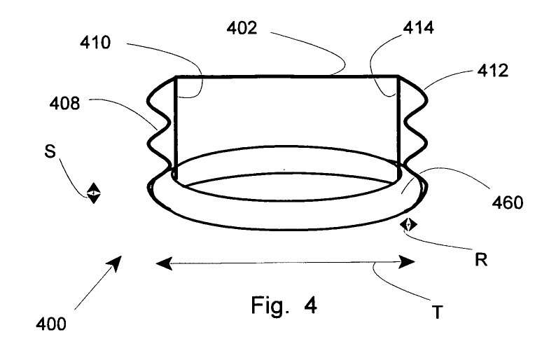

FIG. 4 is an elevated side view of the third embodiment of the invention in use on an Alginate band. Third embodiment 400 has cross piece 402 approximately equal in length L to the diameter R of alginate ring 460. First barb 408, second barb 410, third barb 412, and fourth barb 414 may be seen to be clasping the ring 460 securely. When inserted into a tooth void in a gutta percha negative mold, the Alginate band will act to secure the alginate ring in place despite any shaking as gypsum or plaster is shaken into the mold.

Thickness of ring S and depth of ring T may fit securely into the detents on the barbs if the detents are not quite as large as S and T.

While the alginate band 460 depicted in FIG. 4 is shown as having a definite thickness and semi-circular cross-section, this should NOT be taken as representative of bands in use, and especially not of bands that the invention might be limited to. On the contrary, it is known in the prior art that alginate bands of various different cross sectional shapes, depths, widths and so on may be used, and all such alginate bands now known or later developed may be used with the invention as claimed herein. The alginate band 460 is merely exemplary.

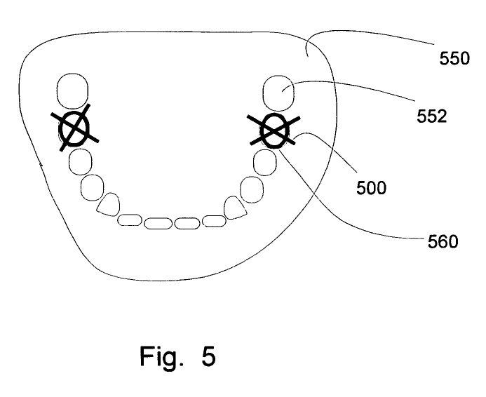

FIG. 5 is a top planform view of the first embodiment of the device in use on a gutta percha negative mold. First embodiment 500 actually sits with the barbs projecting down into the mold 550 on either side of tooth void 552. Alginate band 560 may be seen within the tooth void 552. The width of the tooth void may be used to determine the length of the cross piece of the embodiment or others. The width of the tooth void may be seen to be less than the length of the cross piece of the first embodiment (dimension A in FIG. 1).

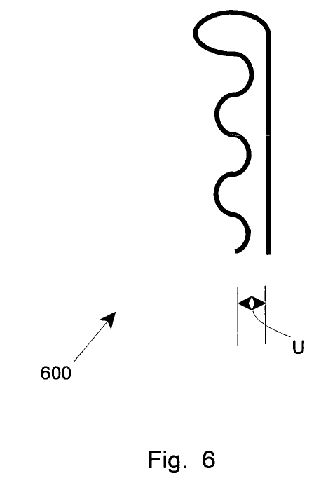

FIG. 6 is a side view of a presently preferred embodiment and best mode now contemplated having the end of the barb ending with a bend outwards for enhanced ease of use. Increased opening width U in embodiment 600 is due to the barb ending with a slight opening: an opening width of 0.023 may be used. In use, this makes the device easier to clip onto an alginate ring or other apparatus. Various advantageous dimensions of the device include a cross piece length of 0.512 inches, a barb length of 0.532 inches, and a wire thickness of either 0.040 or 0.080 inches. In other embodiments, other wire thicknesses may be used, across a wide range from a substantial portion of an inch to very fine wire. While the term wire is used, the bodies may in the preferred embodiment be polymer, may be of a fiat or irregular or other cross section, may be molded and so on.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. An alginate band fastener for use with a alginate band and a soft substrate, the alginate band having an outer configuration, the alginate band fastener comprising:
a cross piece having first and second ends;
at least a first barb projecting from the cross piece at the first end;
at least a second barb projecting from the cross piece at the second end, the second barb approximately parallel to the first barb;
at least the first barb having a first detent dimensioned and configured to physically engage to such alginate band.

2. The alginate band fastener of claim 1, further comprising:
at least one additional detent dimensioned and configured to physically engage such alginate band, the additional detent located upon the second barb.

3. The alginate band fastener of claim 1, further comprising:
a second detent on the first barb, the second detent also dimensioned and configured to physically engage to such alginate band.

4. The alginate band fastener of claim 3, further comprising:
a third detent on the first barb, the third detent also dimensioned and configured to physically engage to such alginate band.

5. The alginate band fastener of claim 1, further comprising:
a third barb projecting from cross piece at the first end, the third barb projecting approximately parallel to the first barb;
a fourth barb projecting from cross piece at the second end, the fourth barb projecting approximately parallel to the second barb;
wherein the first and third barbs have ends disposed in the range from approximately 0.020 to 0.025 inch from each other; and
wherein the second and fourth barbs have ends disposed in the range from approximately 0.020 to 0.025 inch from each other.

6. The alginate band fastener of claim 5, further comprising:
second and third detents on the first barb, the second and third detents also dimensioned and configured to physically engage to such alginate band;
three additional detents on the second barb, the three additional detents also dimensioned and configured to physically engage to such alginate band;
wherein the third and fourth barbs are approximately straight.

7. The alginate band fastener of claim 6, wherein the cross piece and four barbs further comprise:
wire having a diameter in the range from 0.02 inch to 0.08 inch.

8. The alginate band fastener of claim 7, wherein the wire further comprises one member selected from the set consisting of: stainless steel, nickel, brass, bronze, ABS plastic, polymer composites and combinations thereof.

9. An alginate band fastener for use with a alginate band and a soft substrate, the alginate band having an outer configuration, the alginate band fastener comprising:
a straight portion having a first end and a second end;
a loop portion projecting from the second end of the straight portion; and
a detent carrying portion projecting from the loop portion approximately parallel to the straight portion, the detent carrying portion having at least one detent dimensioned and configured to physically engage to such alginate band, the detent carrying portion having a first end.

10. The alginate band fastener of claim 9, further comprising:
wire having a diameter in the range from 0.02 inch to 0.04 inch.

11. The alginate band fastener of claim 10, wherein the wire further comprises one member selected from the set consisting of: stainless steel, nickel, brass, bronze, ABS plastic, polymer composites and combinations thereof.

12. The alginate band fastener of claim 9, wherein the first end of the detent carrying portion and the first end of the straight portion are disposed approximately 0.02 inch apart.

13. The alginate band fastener of claim 9, wherein the loop portion has a width in the range from 0.1 inch inclusive to 0.24 inch exclusive.

14. The alginate band fastener of claim 9, wherein the loop portion has a width in the range from 0.24 inch to 0.25 inch.

15. The alginate band fastener of claim 9, wherein the loop portion has a width in the range from 0.25 inch exclusive to 0.5 inch inclusive.
